(19) United States
(12) Patent Application Publication
(10) Pub. No.: US 2016/0025487 A1
(43) Pub. Date: Jan. 28, 2016

(54) AN APPARATUS AND METHODS FOR IDENTIFYING BOTH SIDES OF A TEST BOARD

(71) Applicant: ABON BIOHPARM (HANGZHOU) CO., LTD, Zhejiang (CN)

(72) Inventors: Jingliu ZHANG, Hangzhou (CN); Kang YANG, Hangzhou (CN)

(21) Appl. No.: 14/774,127

(22) PCT Filed: Mar. 19, 2014
(86) PCT No.: PCT/CN2014/073686

§ 371 Date: Sep. 9, 2015

(30) Foreign Application Priority Data
Apr. 3, 2013 (CN) 201310116247.5
Apr. 3, 2013 (CN) 201320166801.6

(51) Int. Cl. G01B 21/08

(52) U.S. Cl. CPC G01B 21/08

(57) ABSTRACT

An apparatus (10) and method for identifying both sides of a test board (100) are provided. The apparatus (10) comprises a support wall (200) supporting the test board (100) and a component (300, 400) identifying both sides of the test board (100), wherein the distance from the top of such component (300, 400) to the support wall (200) is h3, h2>h3>=h1, in which h1 refers to the base plate thickness of the test board (100) and h2 refers to the height of the fixed leg (103) at one side of the test board (100) and h2>h1. With the apparatus and method, the test board can be sorted to the same side so as to improve the efficiency of mechanical assembly of the test board and reduce the cost.

### FIELD OF THE INVENTION

The present invention relates to an identifying apparatus and methods, particularly to an apparatus and methods for identifying both sides of a test board with test strips.

### BACKGROUND OF THE INVENTION

Immune binding reaction principle is used to test if there is targeted substance in samples. This technology has been widely used in various fields to test the targeted substance in multiple biological samples (saliva, blood, urine, serum and sweat, etc) to monitor illness and human health condition (early pregnancy, tumor, infectious disease and drug, etc). A plurality of such tests can be finished on solid substrate material, such as common lateral flow solid substrate material, glass or plastic porous plate and immunochromatography apparatus, etc. In some tests, to be convenient for the operators' self-detection, test strips to be detected are arranged on the test board and corresponding test strips are arranged on the same test board especially when the same sample is used to detect a plurality of ingredients at the same time.

Generally, such test boards are manually operated with low efficiency and high cost. Therefore, automated assembly with machine is tried in current assembly manufacturing to improve the efficiency and reduce the human cost.

How to make test boards sorted to the same side and the same direction on equipment is a very critical issue in assembly operation of test boards with equipment. In some embodiments, a vibrating disk (this disk like it was dsicripted in published Chinese application, like ZL201220595118.X, 201120106726.5 and 201110091811.3) is used to vibrate and drop test boards onto the subsequent conveyer belt one after another, wherein the vibrating disk randomly arranges test boards on the track and people generally remove test boards in the wrong sort order after observation to ensure detection of the same side. In some other embodiments, a sensing device is used to detect the side and the direction of test boards when they fall onto the conveyer belt with incorrect test boards being taken away by mechanical arms. In such methods, the sort order of test boards is passive with low efficiency and generally will affect efficiency of the overall test board assembly equipment, and will also increase the automated assembly cost with additional equipment.

### SUMMARY OF THE INVENTION

The present invention relates to an apparatus that could automatically identify and sort test boards when assembling test boards with machine or equipment. It can make test boards sorted to the same side (face up or face down, or the other side up or down) and remove test boards in the wrong side at the same time so as to proceed to the next working procedure in order, improving the operation efficiency and reducing the use of extra equipment.

In some preferred embodiments, wherein the test board refers to one of the two plates assembling into the detecting apparatus, it is hoped that one of the two plates (the base plate for example) could face to the same direction, like face up, in automated assembly, so that the other plate (cover) can be put on the base plate to form a detecting apparatus after laminating or assembling. Of course, test strip can be put on the base plate in advance. In this way, test boards can face to the same direction and those towards the wrong direction will be automatically removed. The detailed description is as follows.

This invention relates to an apparatus for identifying both sides of a test board, comprising a support wall supporting the test board and a component identifying both sides of the test board, wherein the distance from the top of the component to the support wall is h3 and there is a fixed leg on one side of the test board, wherein h1 refers to the test board thickness and h2 refers to the fixed leg height and h2>h1, h2>h3≧h1.

In some specific embodiments, the first side is different from the second side of the said test board. It is preferred that there is a protruding fixed leg on one side of the test board (e.g. as the first side) and no such fixed leg on the other side (e.g. as the second side). In preferred embodiments, distance from top of the said component to the support wall is vertical distance or non-vertical distance. In assembled detecting apparatus, the first side refers to the side facing the test strip and the second side refers to the external side and no facing the test strip directly. There is specific and detailed description of such detecting apparatus or detecting box in Chinese patent ZL200720114251.8, 201320263766.X and 200480019963.0.

In a specific embodiment, the identifying component and the support wall are not on the same plane and there is a distance between them, or a distance between top of the identifying component and the support wall. In another specific embodiment, the identifying component is positioned at one side of the support wall and is parallel to it, or forms an angle D with the support wall, wherein 0°<D<180° and could not be 0° or 180° since they cannot be on the same plane.

In a preferred embodiment, there is an angle between the support wall and the horizontal plane which is an assumed plane to represent the positional relation between the support wall and the identifying component.

In the present invention, the support wall refers to a surface supporting the test board or providing the test board with dependence and support, and it is preferred to be a surface vertical or inclined to the horizontal plane. That is to say, there is an angle between the support wall and the horizontal plane, in which way, the test board can fall down freely along the support wall. Suppose there is no coordination from the identifying component, the test board may break away from the support wall due to the action of gravity. In some preferred embodiments, the identifying component and the support wall are not on the same plane. If they are, the identifying component is equivalent to extension of the support wall and plays the same role as the support wall to support the test board. In some preferred embodiments, to make sure the identifying component can accommodate the test board and support it together with the support wall, and can identify test boards facing different sides, the identifying component and the support wall are on the same plane. To be more specific, the identifying component is arranged at one side of the support wall, being in parallel to or with an angle of 0°-180° with the support wall. In this way, between the top of the identifying component and the support wall, a gap can be formed to accommodate an edge of the test board or form a pivot to support the test board edge from falling off the support wall. There is a distance between the top of the identifying component and the support wall, i.e. the gap size or width. In some preferred embodiments, the distance from the top or vertex of the identifying component to the support wall is h3. When the identifying component is parallel to the support wall, the distance from the top or vertex of the identifying component to the support wall is equal to the distance from the identifying component to the support wall. In more specific embodiments, the test board is usually parallel to or leans against the support wall when it is positioned on the support wall, while the top of the identifying component is used to clamp the test board or provides a pivot to it. The identifying component top provides a pivot for the test board to stably lean against the support wall.

In some embodiments, there is a height difference between test boards facing different sides after they move and pass by the identifying component. The side with a fixed leg on the test board is in contact or face to face with the support wall, while the other side without a fixed leg is not. When same test boards pass by the identifying board, there will be a height difference between them since two test boards are in contact with the support wall at different sides. For example, the height of test board being in contact with the support wall at the side with a fixed leg is different from the height of test board being in contact with the support wall at the side without a fixed leg.

In some embodiments, the height difference between test boards facing different sides is used to selectively remove test boards facing the opposite side so as to get test boards facing the same side. For example, in a vibrating device, test boards can move on the track under vibration and some can be selectively removed based on their height difference, finally keeping test boards facing the same side, for instance, keeping all the test boards being in contact or face to face with the support wall at the side with a fixed leg, or all the test boards with the side with a fixed leg facing the outside.

In a specific embodiment, the edge near the fixed leg on the test board is in contact with the top of the identifying component when the side with a fixed leg of the test board is on or face to face with the support wall. In another specific embodiment, the fixed leg of the test board is in contact with the top of the identifying component when the side without a fixed leg of the test board is on or is not face to face with the support wall. In this way, test boards facing different sides are at different height on the identifying component.

In an embodiment, there is a height difference between the side with a fixed leg and the side without a fixed leg after the test board passes the identifying component.

In some preferred embodiments, the fixed leg is not positioned at central position of the test board. It is preferred that the distance from the fixed leg to one edge of the test board is different from the distance to the other edge of the test board with the former being shorter than the latter.

In some preferred embodiments, there is a protruding fixed leg with a height of h2 on one side of the test board and the fixed leg height is greater than the test board thickness h1, i.e. h2>h1. When the distance h3 from the top of the identifying component to the support wall is less than the fixed leg height h2, and h3 is greater than or equal to the test board thickness h1, the fixed leg or one side edge of the test board may be blocked by the identifying component when falling off the support wall. To the specific, when the side without a fixed leg (front of the test board) is in contact or face to face with the support wall, which means when the side with a fixed leg faces the identifying component, the top of the said identifying component is in contact with the fixed leg of the test board. In the meantime, since the distance h3 from the top of the identifying component to the support wall is greater than or equal to the test board base plate thickness h1, part of the test board (the part below the fixed leg until the lower part of the test board) will be positioned in the gap between the support wall and the identifying component; however, when the side with a fixed leg (back of the test side) is on the support wall, the support wall is in contact with the fixed leg and the test board thickness is determined by the fixed leg as h2; when the test board falls down to the top of the identifying component, the entire one side edge of the test board is in contact with the top of the identifying component since the distance h3 is less than h2, which also means the entire test board is on the identifying component. In this way, based on their height difference, test boards facing different sides will be separated by the identifying component.

In a specific embodiment, the component identifying both sides of a test board also comprises a baffle, wherein the baffle is arranged at one side of the support wall and the distance from the top of the said baffle to the support wall is less than the fixed leg height, and is greater than or equal to the test board base plate thickness.

In another specific embodiment, the component identifying both sides of a test board also comprises a groove connected with the support wall bottom, wherein the distance from the top of the outside of the groove to the support wall is greater than or equal to the test board base plate thickness, and is less than the fixed leg height.

In a preferred embodiment, the outer wall of the groove is parallel to the support wall.

In a preferred specific embodiment, the test board thickness is 2 mm, the fixed leg height is 5 mm and the top of outer wall of the groove is 2-4 mm away from the support wall. With such a distance, the side without a fixed leg is on the support wall and the fixed leg is in contact with the top of the groove with part (lower part of the test board to the fixed leg) of the test board falling into the groove; however, the side with a fixed leg is positioned at one side edge of the test board and is in contact with the top of the groove with the entire test board being in the groove. In a specific embodiment, the fixed leg is arranged at back of the test board, which means all the test boards with back in contact with the support wall are on the groove, while all the test boards with front in contact with the support wall are partially in the groove. There is thus a height difference between such test boards facing different sides.

To effectively separate two sides of the test board, in another embodiment, the depth of the groove is greater than or equal to the distance from the test board edge to the fixed leg. In a more specific embodiment, the depth of the groove is greater than or equal to 2 mm.

In some other preferred embodiments, the apparatus also comprises a component removing test boards from the support wall. Since test boards facing different sides are at different height in the aforesaid embodiments, it is possible to remove test boards facing the same side from the support wall or keep them on the support wall. In this way, test boards facing the same side are kept or removed from the support wall so that they can move forward towards the same side.

In more specific embodiments, the said component is positioned on the support wall and the distance h4 from it to the top of the outer wall of the groove is less than or equal to the test board width b; and the distance h4 is greater than the distance a from the fixed leg of the test board to the upper part of the test board, i.e. b>=h4>a.

To be specific, the identifying component distinguishes two sides of the test board based on their height difference and another component is arranged at the height difference area to remove higher test boards and thus separate test boards facing different sides. The height difference distinguished by the identifying component is actually the distance between the lower part of the test board and the fixed leg, which means the highest point of the said component is the test board width b. In such way, it can be assured that test boards with the lower part in contact with the identifying component, i.e. test boards with the fixed leg (front of test boards) in contact with the support wall, can be removed by the component from the support wall; however, the lowest point of the said component must be greater than the result of the test board width minus the distance from the lower part of the test board to the fixed leg, i.e. the distance a from the upper part of the test board to the fixed leg. In this case, it can be ensured that the component will not be in contact with test boards being in contact with the support wall at the side without a fixed leg (front of test boards) and such test boards will not be removed from the support wall. Consequently, the distance h4 from this component to the top of the groove is between a and b, i.e. b>=h4>a, and is optional or can be carried out in the reverse way.

In a specific embodiment, the test board is 50 mm wide and the distance c from the fixed leg at the edge of the test board to the lower part of the test board is 3 mm. Therefore, the distance from the component to the top of the groove is greater than 47 mm and less than or equal to 50 mm. When the fixed leg is positioned at the back of the test board, this distance enables the component to be in contact with test boards being in contact with the support wall at the back and makes such test boards removed from the support wall; at the same time, it can not be in contact with test boards being in contact with the support wall at the front and makes such test boards kept on the support wall. In such circumstance, this component can make test boards with back in contact with the support wall removed from the support wall and the groove, and keep all the test boards with front in contact with the support wall, realizing the function of sorting test boards to the same side.

In a specific embodiment, the component is an air pipe positioned on the support wall, through which the air blown makes test boards being in contact with the support wall at the side with a fixed leg, i.e. test boards with back in contact with the support wall, be driven by the air pressure and break away from the groove and the support wall and those test boards facing the same side can remove from the support wall.

In another specific embodiment, the component is a bulge on the support wall, through which test boards being in contact with the support wall at the side with a fixed leg, i.e. test boards with the back in contact with the support wall, are popped out and break away from the support wall and those test boards facing the same side can remove from the support wall.

In another aspect, the present invention also comprises methods for identifying both sides of a test board, to be specific, putting the test board on the support wall and making it move to the identifying component to get in contact with it, wherein making the distance h3 from the identifying component to the support be less than h2 and greater than or equal to h1, in which h1 refers to the test board base plate thickness and h2 refers to the fixed leg height at one side of the test board and h2>h1.

In a preferred embodiment, the identifying component is not at the same plane with the support wall, but is parallel to it or has an angle with it.

In further embodiments, the lower part of the test board is in contact with the top of the identifying component when the side with a fixed leg of the test board is on the support wall; and the fixed leg of the test board is in contact with the top of the identifying component when the side without a fixed leg of the test board is on the support wall.

In a specific embodiment, the identifying component also comprises a groove connected with the support wall bottom and the distance from the top of the outer wall of the said groove to the support wall is h3: h2>h3>=h1.

In some other embodiments, it also comprises a component removing test boards whose sides with a fixed leg are on the support wall away from the support wall.

In specific embodiments, the component is an air pipe on the support wall, wherein the distance h4 from the air pipe to the top of outer wall of the groove is between the test board width b and the distance a from the fixed leg to the upper part of the test board.

Meanwhile, the present invention also provides an apparatus that could automatically identify and sort test boards when using machine or equipment in test board assembly, through which test boards facing the same side can be sorted and proceed to the next working procedure to improve the operating efficiency. In the abovementioned embodiments, test boards facing the same side can move forward, but there are usually front and back of test boards. It is hoped to make all the test boards face front, with removing those failing to do so.

Beneficial effects

By using the apparatus and methods in the present invention to identify and sort test boards, test boards can be sorted to the same side, which improves the efficiency of the test board assembly with machine and reduces the cost.

### BRIEF DESCRIPTION OF THE DRAWINGS

FIG. 1 shows the schematic equipment view including the apparatus in the present invention;

FIG. 2 shows the schematic front view of a test board in the present invention;

FIG. 3 shows the schematic back view of a test board in the present invention;

FIG. 4 shows the schematic side view of a test board in the present invention;

FIG. 5 shows the schematic sectional view of the apparatus identifying both sides of a test board in the present invention; wherein, the support wall and the identifying component in FIG. 5a and FIG. 5d are at vertical position; and the support wall and the identifying component in FIG. 5b and FIG. 5e are tilted with an angle; and the support wall and the identifying component in

FIG. 5c and FIG. 5f are tilted and parallel;

FIG. 6 shows the schematic view for coordination among the test board, the support wall and the identifying component;

FIG. 7 shows the projection schematic view for coordination among the test board, the support wall and the identifying component;

FIG. 8 shows another projection schematic view for coordination among the test board, the support wall and the identifying component;

FIG. 9 shows the schematic view of the division of height of test boards facing different sides with coordination of the identifying component and the support wall in a specific embodiment;

FIG. 10 shows the schematic view of the division of height of test boards facing different sides with coordination of the identifying component and the support wall in another specific embodiment.

### BRIEF DESCRIPTION OF MARKS ON THE DRAWINGS:

An apparatus 10 identifying both sides of a test board; an apparatus 20 identifying different directions of a test board; an equipment 30 comprising the two apparatuses; a test board 100; a test board window 101; test board intervals 102, 1021, 1022, 1023, 1024, 1025, 1026 and 1027; a fixed leg 103 on the back of a test board; the front 107 of a test board (the side without a fixed leg); the back 108 of a test board (the side with a fixed leg); one side edge 105 of a test board; the other side edge 106 of a test board; a support wall 200; components 300 and 400 identifying test boards; tops 301 and 401 of the identifying component; a component & air pipe 500; and a groove 501

### Description of the Preferred Embodiment

Structure or technical terms involved in the present invention will be further illustrated next. In the following detailed description, reference text for the legend is a part of it and examples will be given to describe possible specific program to be executed in the present invention. We do not rule out other specific programs and we might change structure of the present invention under the circumstance of not violating the application range of the present invention.

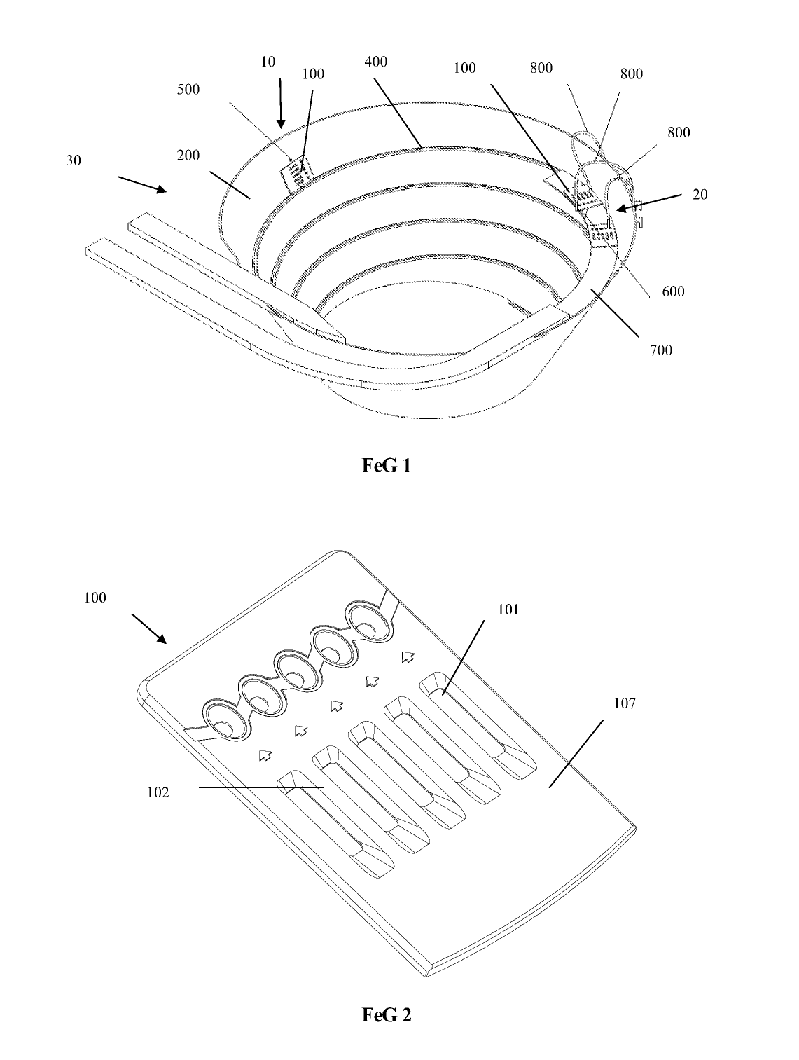

For example, FIG. 1 shows an equipment 30 used to sort a test board 100 to the same side or same direction and the apparatus 10 identifying both sides of a test board is applied on such equipment 30, being able to make such equipment 30 sort test boards to the same side. At the same time, on the equipment 30, there is also an apparatus 20 arranging test boards to the same direction which could sort test boards facing the same side to the same direction again. The apparatus 10 and the apparatus 20 could make the equipment 30 sort test boards to the same side and the same direction and proceed to the next working procedure. In the meanwhile, they can improve the efficiency of the equipment 30 which generally uses a vibrating plate to randomly vibrate test boards and make them move forward along the track.

Generally, test boards to be assembled comprise the upper test board and the lower test board. Put test strip on the lower test board, then put the upper test board on the lower test board and laminate them and a final test reagent board will be formed.

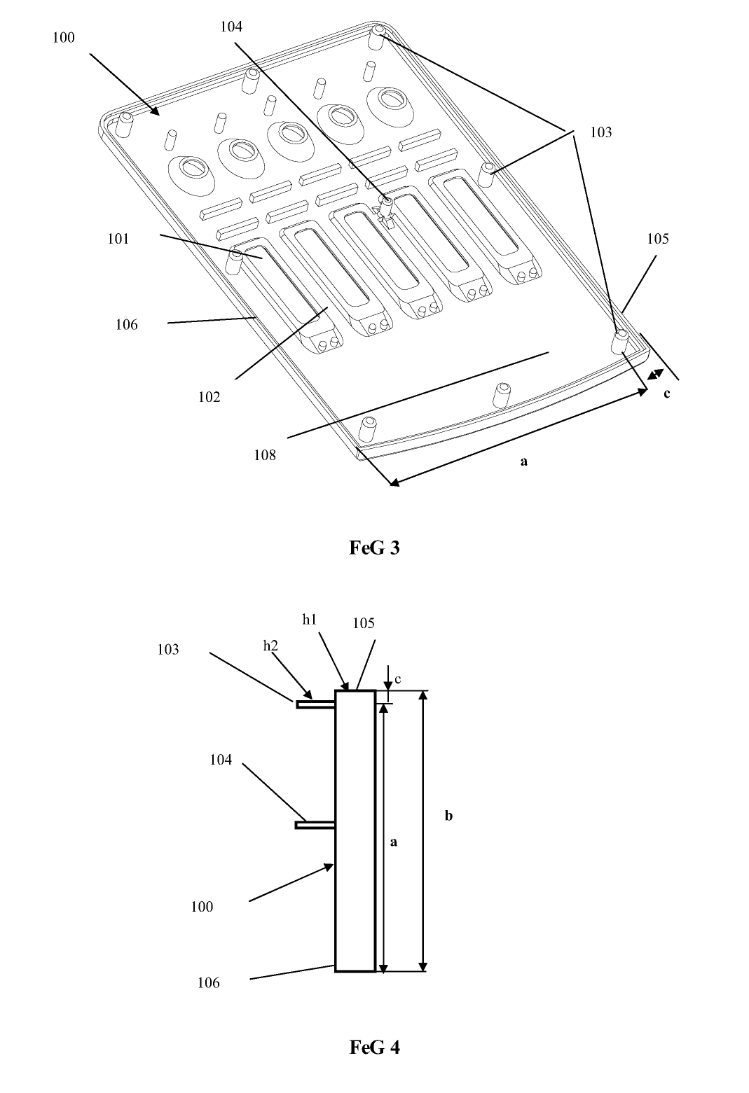

In a specific embodiment, the part of the test board assembled with the present invention as shown in FIG. 2 and FIG. 3, is the upper test board. FIG. 2 shows the schematic front view of the upper test board 100 and FIG. 3 shows the schematic back view of the upper test board 100. The said test board 100 is made up of plates and there is a window 101 displaying the test strip result and an interval 102 between two windows. At the edge of the test board, there is a bulge—a fixed leg 103, assorted with the socket of another test board (the lower test board). Height h2 of the fixed leg 103 is greater than the test board 100 thickness h1. In general, the test board 100 is 1-3 mm thick. In a specific embodiment, the test board 100 is 2 mm thick and the fixed leg 103 is 5 mm high.

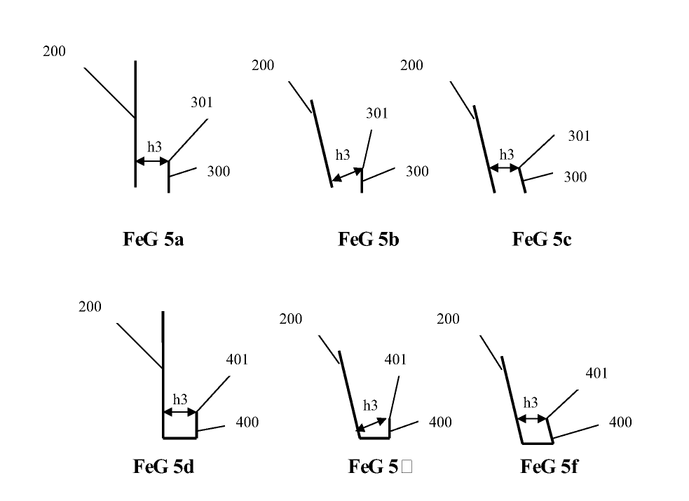

In a preferred embodiment, the fixed leg is not positioned at center of the test board. It is preferred that the fixed leg is not positioned in the middle or at the center of the horizontal position of the test board. For example, the fixed leg can be positioned near one side edge of the test board and away from the other side edge. In some preferred embodiments, the fixed leg 103 is near one side edge 105 and away from the other side edge 106. For instance, the fixed leg 103 is positioned near one side edge of the test board 100 with a distance c from this edge (one side edge 105 of the test board) as shown in FIG. 4 and FIG. 3. At the same time, the fixed leg 103 is away from another side edge (another side edge 106 of the test board) with a distance a, wherein c is less than a. The sum of the distance a and c is the test board width b. In some preferred embodiments, there might be two or more than two fixed legs. In some preferred embodiments, fixed legs are evenly arranged longitudinally along the test board in equidistance (FIG. 3). In some other embodiments, the distances from each fixed leg to one side edge of the test board are not always the same and they might be different distances.

In a specific embodiment, the test board 100 is 50 mm wide and the distance c from the fixed leg 103 to one side edge of the test board is 3 mm and the distance a to the other side edge is 47 mm.

In some other embodiments, the test board further comprises another support pin 104 which is used to support the cover of the test board 100 to ensure the distance between the cover and the lower board after laminating to avoid compression upon the test strip in the test board.

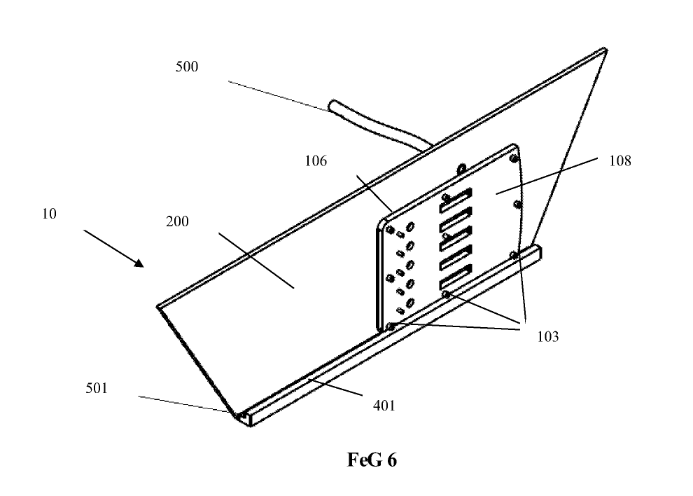

In the present invention, the apparatus identifying both sides of a test board comprises the support wall 200 and the identifying component 300 or 400. As shown in FIG. 5a to FIG. 5f, the support wall 200 is used to bear the test board 100 and is able to make the test board 100 fall freely along the support wall 200. Consequently, in some specific embodiments, the support wall 200 is not positioned at the horizontal position, but has an angle with the horizontal plane. In such way, in case of no coordination of the identifying component and the support wall, the test board can fall onto the support wall freely. As shown in FIG. 5a and FIG. 5d, the support wall 200 is vertical to the horizontal plane; while in FIGS. 5d and 5c, the support wall 200 is tilted to the horizontal plane. The component 300 or 400 identifying both sides of the test board is positioned at one side of the support wall 200. For instance, it is positioned at the same side of the support wall 200 to bear the test board 100 falling from the support wall 200. Such identifying component 300 or 400 could be parallel to the support wall 200, or has an angle with it. The identifying component 400 can also be connected with the support wall 200 as shown in FIG. 5d to FIG. 5f; or it can not be connected with it as shown in FIG. 5a to FIG. 5c. No matter what position relation the identifying component 300 or 400 is with the support wall 200, there is a distance from the top 301 or 401 of the identifying component to the support wall 200, forming a gap with a distance h3. In such circumstance, the identifying component coordinates with the support wall so that the test board can be kept on the structure formed by them instead of free falling and breaking away from such structure.

To make sure the test board 100 falling from the support wall 200 can be distinguished by the identifying component 300 or 400 into different sides, there are some requirements on the distance h3. To be specific, the distance h3 is between the test board 100 thickness h1 and the fixed leg height h2, wherein the test board thickness generally stands for thickness of the test board itself, including the thickness forming the concave plane 701 of the test board and height of the side edge surrounding the concave plane 701. Under normal circumstances, the test board thickness is substantially the same at different parts. Sometimes, the test board thickness might differ at different parts, for example, the side edge 105 near the fixed leg 103 might be higher than the other side edge 106 away from the fixed leg. Under such circumstance, the test board thickness might differ and the test board thickness h1 can refer in particular to the test board thickness near the fixed leg. As shown in FIG. 3, if height of the side edge 105 near the fixed leg is greater than that of the side edge 106, the said test board thickness h1 refers to the sum of the height of the side edge 105 near the fixed leg and thickness of the concave plane of the test board. The above descriptions suggest that the fixed leg height is greater than the test board thickness h1, which means the fixed leg height is greater than the side edge height and that is the bulge from the concave plane of the test board.

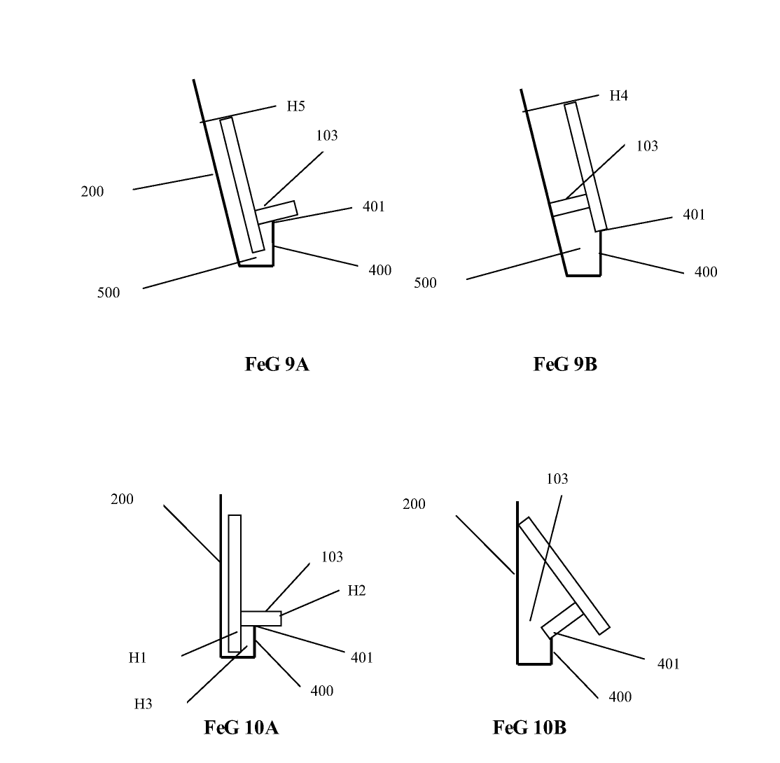

In the present invention, two sides of the test board 100 are differentiated based on their difference. To be specific, there is a raised fixed leg 103 on the back 108 of the test board, which is used to differentiate test boards 100 facing different sides. That is to say, the identifying component 300 or 400 is used to contact the fixed leg 103 so as to identify the side of the test board 100. To be more specific, the distance h3 from the identifying component 300 or 400 to the support wall 200 is used to distinguish test boards 100 facing different sides because when the front 107 of the test board (without fixed leg or the fixed leg height is less than the fixed leg height on the back) is on the support wall 200 (i.e. in contact with the support wall 200), the fixed leg 103 on the back 108 faces the identifying component 300 or 400, which means when the side with a fixed leg is not face to face with the support wall and h3 is at an appropriate distance, the fixed leg 103 will be stuck or supported by the top (top 301, 401) of the identifying component so that the test board 100 cannot fall down and therefore such test board is provided with a height H4 on the support wall 200 (FIG. 10A and FIG. 9A). However, when the back 108 of the test board, i.e. the side with a fixed leg 104 is in contact with the support wall 200, to differentiate the test board 100 at this time from the test board 100 in front contact with the support wall 200, the distance h3 from the top 301 or 401 of the identifying component to the support wall 200 shall make the entire test board not fall into the distance h3, which means the top 301 or 401 of the identifying component is used to stuck the side edge 105 of the test board 100. At this time, the test board 100 with fixed leg 104 in contact with the back of the support wall 200 is provided with another height H5 on the support wall (FIG. 10B and FIG. 9B). The height H4 is different from H5, which means two sides of the test board will be at different height on the support wall 200 after passing the identifying component 300 or 400. Whereas different sides will be at different heights on the support wall, it provides technical foundation for the differentiation of test boards facing different sides. To obtain such results and make sure part (such as one side edge 105) of the test board with front in contact with the support wall can fall into the gap formed between the identifying component 300 or 400 and the support wall 200, the gap width h3 shall be greater than or equal to the test board thickness h1; however, to make sure part (such as one side edge 105) of the test board with back in contact with the support wall can be stuck by the identifying component 300 or 400 without falling into the gap, the gap distance h3 shall be less than the widest part of the test board—the fixed leg 104 height h2. Of course, embodiment contrary to the aforesaid way is also possible. The height H4 can be greater than or less than H5, but they cannot be the same.

To be more specific, the test board 100 is always moving forward on the support wall 200 and test boards facing different sides are respectively moving forward at two different heights so that the identification of the front and back of the test board 100 can be realized efficiently.

In some specific embodiments, such identifying component is a baffle 300 positioned at one side of the support wall and the baffle is parallel to the support wall 200 as shown in FIG. 5a and FIG. 5c, or might not be parallel to it as shown in FIG. 5b. Length of the baffle is limited, but the vertical distance h3 from the top 301 of the baffle 300 to the support wall 200 shall be between the test board thickness h1 and the fixed leg height h2, i.e. h2>h3≧h1.

In another specific embodiment, such identifying component is a groove 501 connected with the support wall bottom, with which the test board 100 falling into the gap will fall into the groove 501, which is convenient for the next operation, for instance, to be delivered by the equipment to the next working procedure. As shown in FIG. 5d, FIG. 5e and FIG. 5f, outer wall 401 of the groove can be parallel to or form an angle with the support wall 200, however, the distance h3 from the top 401 of the outer wall of the groove to the support wall 200 shall be less than the height h2 of the fixed leg 103 of the test board and greater than or equal to the test board thickness h1. In a specific embodiment, the distance h3 is between 2-4 mm.

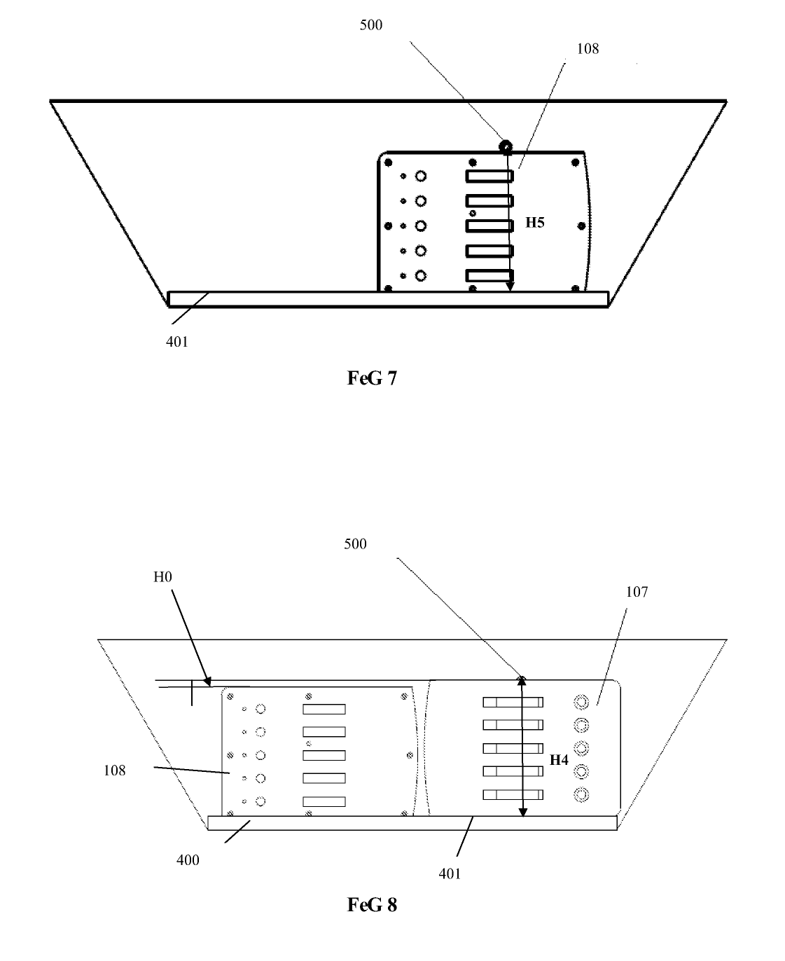

In a specific embodiment, there is a groove 501 connected with the support wall bottom and the outer wall 401 of the groove is parallel to the support wall 200, forming a 3 mm gap between them. At this time, the vertical distance h3 from the top 401 of the outer wall of the groove to the support wall 200 is also 3 mm. As shown in FIG. 5, when the thickness is 2 mm and the front 107 of the test board with a 5 mm high fixed leg at the back edge is in contact with the support wall 200, since the thickness 2 mm is less than the width 3 mm of the groove 501 (distance from the top of the outer wall of the groove to the support wall), the test board 100 will fall into the groove 501. At the same time, since the width 3 mm of the groove 501 is less than the height 5 mm of the fixed leg 103 of the test board, the test board will be stuck when falling to the fixed leg 103 in contact with the top 401 of the outer wall of the groove and stop moving to the groove 300 as shown in FIG. 6 and FIG. 7. However, as shown in FIG. 8, when the test board is opposite, which means when the back 108 is in contact with the support wall 200, the overall thickness turns into 5 mm because of supporting of the fixed leg 103, thus being greater than the width 3 mm of the groove 501, and cannot fall into the groove 501 during falling, but with one side edge of the test board falling onto the top 401 of the groove. Therefore, the front test board 100 and the back test board 100 fall at different heights, forming a height difference, and can thus be differentiated.

In a preferred embodiment, to make sure two sides of the test board 100 can be effectively separated, depth of the groove 501 is greater than or equal to the distance c from the fixed leg 103 to the lower part 105 of the test board. In a specific embodiment, the distance c is 3 mm and the depth of the groove 501 is 3-5 mm.

In some embodiments, to separate test board 100 facing front and facing back, the apparatus 10 further comprises a component 500 removing test boards as shown in FIG. 6, FIG. 7 and FIG. 8, and it is positioned on the support wall 200 and above the groove 501. To be more specific, the component 500 is positioned at the height difference (height difference HO between H4 and H5) between the front and the back test board 100 formed by the groove 501 at the bottom of the support wall 200 (FIG. 8).

In a preferred embodiment, as shown in FIG. 7 and FIG. 8, the distance h4 from the component 500 to the top 401 of the groove is between the test board width b and the distance a from the fixed leg 103 to the upper part 106 of the test board. To completely separate distinguished front test board 100 from back test board 100, there is one way to remove one kind of test board 100 (front or back test board) away from the support wall 200. To realize this function, the component 500 positioned on the support wall 200 must be within the height difference h0 formed by the groove 501 between the front test board and the back test board as shown in FIG. 8. When the component 500 is positioned at such position, since the front test board 100 (the test board with back in contact with the support wall) is higher, it will be in contact with the component 500 and be removed from the support wall 200. At the same time, since the top 106 of the back test board (the test board with front in contact with the support wall) is lower than this height difference, it will not be contact with the component 500 and can be kept on the support wall 200. The height difference h0 is actually the distance c from the test board bottom 105 to the neighboring fixed leg 103. Meanwhile, lowest position of the component 500 on the support wall 200 shall make sure it cannot be contact with the back test board 100 and must be contact with the front test board 100. As a result, the distance h4 from the component 500 to the top 401 of the groove shall be greater than the result of the test board width b minus the distance c from the bottom 105 of the test board to the neighboring fixed leg 103, i.e. a and a=b−c, h4>a (i.e. b−c); in addition, the distance h4 shall be less than the test board width b, i.e. h4<b. In a specific embodiment, the test board width b is 50 mm and the distance c is 3 mm, and therefore a is 47 mm and h4 is between 47-50 mm. To be specific, the distance h4 from the component 500 to the top 401 of the groove is 48 mm.

In another specific embodiment of the present invention, the component removing test boards is an air pipe 500 and it can be connected with the air pump at the other end which continuously blows air to the test board via the air pipe 500 so that the test board in contact with the air pipe can be blown away from the support wall 200. On the contrary, test boards not blown away are facing the same side and will move forward on the equipment track.

In another specific embodiment, the component 500 is a bulge on the support wall, through which the test board being in contact with the support wall at the side 108 with a fixed leg, i.e. the test board 100 with back in contact with the support wall, can be popped out and break away from the support wall 200. The bulged height is slightly higher than the fixed leg height on the test board. In this way, the bulge can be in contact with the test board 100 and pop it away from the support wall 200. The bulged height may be randomly set up.

1. An apparatus for identifying both sides of a test board, comprising:
a support wall supporting the test board and a component identifying the first side and the second side of the test board, wherein the distance between the top of the said component and the support wall is h3 and there is a fixed leg on the first side of the test side, wherein h1 refers to the test board thickness and h2 refers to the fixed leg height and h2>h1, h2>h3≧h1.

2. The apparatus according to claim 1, wherein the fixed leg is not located at the central of the test board.

3. The apparatus according to claim 2, wherein the distance between the fixed leg and one edge of the test board is different from the distance between the fixed leg and the other edge of the test board.

4. The apparatus according to claim 3, wherein the distance between the fixed leg and one edge of the test board is shorter than that between the fixed leg and the other edge of the test board.

5. The apparatus according to claim 1, wherein the identifying component is positioned at one side of the support wall and is parallel to it, or the identifying component forms an angle D with the support wall, wherein 0°<D<180°.

6. The apparatus according to claim 1, wherein there is a height difference between test boards facing different sides after they move and pass by the identifying component.

7. The apparatus according to claim 6, wherein the edge near the fixed leg on the test board is in contact with top of the identifying component when the side with fixed leg of the test board is on or in face-to-face contact with the support wall.

8. The apparatus according to claim 6, wherein the fixed leg of the test board is in contact with top of the identifying component when the side without fixed leg of the test board is on the support wall.

9. The apparatus according to claim 1, wherein the said component identifying both sides of the test board comprises a groove connected with the support wall bottom.

10. The apparatus according to claim 9, wherein the outer wall of said groove is parallel to the support wall.

11. The apparatus according to claim 10, wherein the top of the outer wall of the said groove is 2-4 mm away from the support wall.

12. The apparatus according to claim 1, wherein this apparatus also comprises a component for removing the test board from the support wall.

13. The apparatus according to claim 12, wherein the said component is positioned on the support wall and the distance h4 from the component to the top of the outer wall of the groove is less than or equal to the width b of the test board cover, and the distance h4 is greater than the distance a from the fixed leg to the upper part of the test board.

14. The apparatus according to claim 13, wherein the said component comprises an exhaust pipe on the support wall and the distance h4 from the exhaust outlet to the top of the outer wall of the groove is less than or equal to the width b of the test board cover, and the distance h4 is greater than the distance a from the fixed leg to the upper part of the test board.

15. The apparatus according to claim 1, wherein first side and second side of the said test board are different in structure.

16. An apparatus that could identify both sides of test board, comprising a support wall for the test board and a component identifying the first side and the second side of the test board, wherein the identifying component is at different heights of the support wall when the test board passes by such apparatus.

17. The apparatus according to claim 13, wherein the different height is realized in the following way: the distance from the top of the said component to the support wall is h3 and there is a fixed leg on the first side of the said test side, wherein h1 refers to the test board thickness and h2 refers to the fixed leg height and h2>h1, h2>h3≧h1.
